(19) United States
(12) Patent Application Publication
(10) Pub. No.: US 2026/0252469 A1
(43) Pub. Date: Aug. 27, 2026

(54) DEVICE HEALTH MONITOR USING PROGRAM SIGNATURE PATTERN

(71) Applicant: Microchip Technology Inc., Chandler, AZ (US)

(72) Inventors: Andrei Bucsa, Gilbert, AZ (US); Stephen Bowling, Chandler, AZ (US)

(73) Assignee: Microchip Technology Inc., Chandler, AZ (US)

(21) Appl. No.: 19/374,046

(22) Filed: Oct. 30, 2025

Related U.S. Application Data
(60) Provisional application No. 63/764,323, filed on Feb. 27, 2025.

(51) Int. Cl. G06F 11/3668

(52) U.S. Cl. CPC G06F 11/3672

(57) ABSTRACT

A device for monitoring the operation of a processor includes a program signature pattern stored in a first memory, the program signature pattern corresponding to an external program to be run on an external device; an input signal; a timer module to capture a frequency and a captured duty cycle of the input signal over time; and a decoder to determine an external program state of the external program based on the captured duty cycle. The device may include a second memory to store the external program state and a cross correlator to determine an external program health score based on comparing the program signature pattern stored in the first memory with the external program state stored in the second memory. The device may include a reset output signal and a reset logic to assert the reset output signal when the external program health score is below a predetermined threshold.

### PRIORITY

This application claims priority to commonly owned U.S. Patent Application No. 63/764,323 filed Feb. 27, 2025, the entire contents of which are hereby incorporated by reference for all purposes.

### FIELD OF THE INVENTION

This disclosure enables devices, systems and methods for monitoring the operation of a processor.

### BACKGROUND

High level Safety Integrity Level (SIL) Safety Applications may require constant checks to validate if the system perform is performing within the nominal conditions. A traditional watchdog relies on a live signal transmitted at a specific interval by the main processor that retriggers a timer. If the live signal drops for a period of time, the watchdog decides that the main processor has hung (or is in an unknown state) and will reset it. This approach may require the use of software resources on the system which may be disadvantageous (e.g., more complex software integration (inserting health monitoring code into the target code), verification, etc.). In addition, this approach may be limited to checking for an unresponsive processor and may miss other less obvious problems such as irregularities in the system clock.

Thus, what is needed is a watchdog function that achieves a high level of SIL without these drawbacks.

### SUMMARY

According to one example of this disclosure, a device may include a program signature pattern stored in a first memory, the program signature pattern corresponding to an external program to be run on an external device. The device may include an input pin for receiving an input signal, a timer module configured to capture a frequency and a captured duty cycle of the input signal over time, and a decoder configured to determine an external program state of the external program based on the captured duty cycle. The device may include a second memory configured to store the external program state and a cross correlator configured to determine an external program health score based on comparing the program signature pattern stored in the first memory with the external program state stored in the second memory. The device may include a reset logic configured to assert a reset output signal when the external program health score is below a predetermined threshold.

In the example of the preceding paragraph or in different examples, the program signature pattern may include data representing a sequence of system interrupts predicted to be triggered by the external program when run on the external device.

In the examples of the preceding two paragraphs or in different examples, the cross correlator may be configured to use a sliding window technique to synchronize the program signature pattern stored in the first memory and the external program state stored in the second memory.

In the examples of the preceding three paragraphs or in different examples, the first memory may be a circular buffer.

In the examples of the preceding four paragraphs or in different examples, the second memory may be a FIFO.

In the examples of the preceding five paragraphs or in different examples, the device may include a clock validator configured to validate, based on the frequency and the captured duty cycle of the input signal over time, a supervised clock signal from the external device.

According to another example of this disclosure, a system may include a first device having a system clock, a reset input pin, a system clock divider configured to generate a divided system clock based on the system clock, a pulse width modulation circuit configured to generate a pulse width modulated signal having a duty cycle, and a watchdog output pin coupled to the pulse width modulated signal. A counter of the pulse width modulation circuit may be configured to be clocked by the divided system clock and the duty cycle of the pulse width modulated signal may be configured to encode a plurality of system interrupt signals during execution of an application program.

In the example of the previous paragraph, the system may include a second device having a first memory configured to store a program signature pattern, the program signature pattern corresponding to the application program to be executed on the first device. The system may include a second device having a watchdog input pin for receiving a watchdog input signal coupled to the watchdog output pin of the first device, a timer module configured to capture a frequency and a captured duty cycle of the watchdog input signal over time, and a decoder configured to determine an external program state of the application program based on the captured duty cycle. The system may include a second device having a second memory configured to store the external program state and a cross correlator configured to determine an external program health score based on comparing the program signature pattern stored in the first memory with the external program state stored in the second memory. The system may include a second device having a reset output pin coupled to the reset input pin of the first device and a reset logic configured to assert a reset signal coupled to the reset output pin when the external program health score is below a predetermined threshold.

In the examples of the preceding two paragraphs or in different examples, the duty cycle of the pulse width modulated signal may be configured to encode the plurality of system interrupt signals based on a priority ranking of the plurality of system interrupt signals.

In the examples of the preceding three paragraphs or in different examples, the program signature pattern may include data representing a predicted sequence of the plurality of system interrupt signals during execution of the application program on the first device.

In the examples of the preceding four paragraphs or in different examples, the cross correlator may be configured to use a sliding window technique to synchronize the program signature pattern stored in the first memory and the external program state stored in the second memory.

In the examples of the preceding five paragraphs or in different examples, the pulse width modulation circuit may be configured to update the duty cycle of the pulse width modulation signal when the counter reaches a maximum value.

In the examples of the preceding six paragraphs or in different examples, the first device may include a reset circuit configured to initiate a system reset based on the reset input pin.

In the examples of the preceding seven paragraphs or in different examples, the second device may include a clock validator configured to validate, based on the frequency and the captured duty cycle of the watchdog input signal over time, the first device system clock.

In the examples of the preceding eight paragraphs or in different examples, the system may include a bidirectional and asynchronous serial data connection between the first device and the second device.

In the examples of the preceding nine paragraphs or in different examples, the program signature pattern may include at least one probabilistic data. The second device may include a first additional cross correlator configured to generate a first pattern valid signal based on comparing a first value from the program signature pattern stored in the first memory with the external program state stored in the second memory. The second device may include a second additional cross correlator configured to generate a second pattern valid signal based on comparing a second value from the program signature pattern stored in the first memory with the external program state stored in the second memory. The reset logic may be configured to assert the reset signal coupled to the reset output pin based on the external program health score, the first pattern valid signal, and the second pattern valid signal.

According to another example of this disclosure, a method may include storing a software fingerprint in a memory on a watchdog device, the software fingerprint based on software events predicted to occur during execution of a software program on a subject device, the software program substantially without health check related code. The method may include receiving an encoded signal encoding a plurality of software events that occur during execution of the software program on the subject device. The method may include decoding the encoded signal as a decoded signal on the watchdog device and comparing the decoded signal to the software fingerprint stored in the memory on the watchdog device. The method may include determining a software program health score based on comparing the software fingerprint stored in the memory on the watchdog device with the decoded signal. The method may include asserting a reset output for resetting the subject device when the software program health score is below a predetermined threshold.

In the examples of the preceding paragraph or in different examples, the method may include validating a system clock of the subject device based on the encoded signal.

In the examples of the preceding two paragraphs or in different examples, the software events predicted to occur may include system interrupt events and the software fingerprint may be based on a priority ranking of the system interrupt events.

In the examples of the preceding three paragraphs or in different examples, the method may include determining that the software program has been altered when the software program health score is below the predetermined threshold.

In the examples of the preceding four paragraphs or in different examples, the comparing the software fingerprint stored in the memory on the watchdog device with the decoded signal may include using a sliding window technique to synchronize the software fingerprint stored in the memory on the watchdog device with the decoded signal.

In the examples of the preceding five paragraphs or in different examples, determining the software program health score may be based on artificial intelligence inferencing.

According to another example of this disclosure, a method may include receiving a plurality of parameter sets, each set of the plurality of sets having at least one parameter value corresponding to at least one configuration parameter of a watchdog circuit of a supervised electronic device. For each set of the plurality of parameter sets, the method may include: (1) programming the at least one configuration parameter of the watchdog circuit with the at least one parameter value; (2) executing, by a processor of the supervised electronic device, a program including a plurality of executable instructions; (3) generating output data corresponding to a plurality of events occurring in the supervised electronic device during the executing of the program; and (4) transmitting the output data for receipt by an external device.

In the examples of the preceding paragraph or in different examples, the plurality of events occurring in the supervised electronic device during the executing of the program may include a plurality of system interrupt events occurring in the supervised electronic device during the executing of the program.

In the examples of the preceding two paragraphs or in different examples, the plurality of system interrupt events may be included in the output data based on a priority ranking of the system interrupt events occurring in the supervised electronic device during the executing of the program.

In the examples of the preceding three paragraphs or in different examples, the at least one configuration parameter of a watchdog circuit may include a clock divisor parameter and generating the output data may be based on sampling the plurality of system interrupt events at a frequency based at least on the clock divisor parameter.

In the examples of the preceding four paragraphs or in different examples, the method may include storing at least one repeating pattern selected as a valid watchdog signature pattern in a memory on a watchdog device and determining, by the watchdog device, a health score of the supervised electronic device based on the at least one repeating pattern selected as a valid watchdog signature pattern.

According to another example of this disclosure, a method may include establishing a plurality of parameter sets, each set of the plurality of sets having at least one parameter value corresponding to at least one configuration parameter of a watchdog circuit of a supervised electronic device. For each set of the plurality of parameter sets, the method may include: (1) transmitting the at least one parameter value to the supervised electronic device; (2) receiving program data corresponding to a plurality of events occurring in the supervised electronic device during execution of a program using the at least one parameter value; and (3) when the program data includes a repeating pattern in the plurality of events occurring in the supervised electronic device during the executing of the program, selecting the set of the plurality of parameter sets as a valid watchdog signature parameter set and selecting the repeating pattern as a valid watchdog signature pattern corresponding to the valid watchdog signature parameter set.

In the examples of the preceding paragraph or in different examples, the plurality of events occurring in the supervised electronic device during the executing of the program may include a plurality of system interrupt events occurring in the supervised electronic device during the executing of the program.

In the examples of the preceding two paragraphs or in different examples, the plurality of system interrupt events may be included in the program data based on a priority ranking of the system interrupt events occurring in the supervised electronic device during the executing of the program.

In the examples of the preceding three paragraphs or in different examples, the at least one configuration parameter of the watchdog circuit may include a clock divisor parameter, and the program data may be based on sampling the plurality of system interrupt events at a frequency based at least on the clock divisor parameter.

In examples of the preceding four paragraphs or in different examples, the method may include transmitting the at least one repeating pattern selected as a valid watchdog signature pattern to a watchdog device, and determining, by the watchdog device, a health score of the supervised electronic device based on the at least one repeating pattern selected as the valid watchdog signature pattern.

### BRIEF DESCRIPTION OF THE DRAWINGS

The figures illustrate example systems and methods for monitoring the operation of a processor.

FIG. 1 illustrates a block diagram of an example apparatus for monitoring the operation of a processor.

FIG. 2 illustrates a block diagram of an example apparatus for monitoring the operation of a processor.

FIG. 3 illustrates a block diagram of an example system for monitoring the operation of a processor.

FIG. 4 illustrates a block diagram of an example system for monitoring the operation of a processor.

FIG. 5 illustrates a block diagram of an example system for monitoring the operation of a processor.

FIG. 6 illustrates a block diagram of an example system for monitoring the operation of a processor.

FIG. 7 illustrates a block diagram of an example system for monitoring the operation of a processor.

FIG. 8 illustrates a flow chart of an example method for monitoring the operation of a processor.

FIG. 9 illustrates a flow chart of an example method for monitoring the operation of a processor.

FIG. 10 illustrates a flow chart of an example method for monitoring the operation of a processor.

FIG. 11 illustrates a flow chart of an example method for determining a signature pattern for monitoring the operation of a processor.

FIG. 12 illustrates a flow chart of an example method for determining a signature pattern for monitoring the operation of a processor.

FIG. 13 illustrates a block diagram of an example logic for generating a PWM signal having a duty cycle corresponding to the state of various system interrupt signals during execution of a program on an electronic device.

FIGS. 14a-14c illustrate an example of cross correlator determining an external program health score related to a monitored device.

FIG. 15 illustrates an example block diagram of multiple cross correlators for monitoring the operation of a processor.

FIG. 16 illustrates a block diagram of a software signature pattern extraction and optimization fixture.

FIG. 17 illustrates a block diagram of an example system for monitoring the operation of a processor.

FIG. 18 illustrates a flow chart of an example method for determining a signature pattern for monitoring the operation of a processor.

FIG. 19 illustrates a flow chart of an example method for determining a signature pattern for monitoring the operation of a processor.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

The following description sets forth examples of the present disclosure. It should be recognized, however, that such description is not intended as a limitation on the scope of the present disclosure. Rather, the description also encompasses combinations and modifications to the examples described herein.

The present disclosure avoids one or more of the disadvantages of a traditional watchdog function by providing a watchdog device capable of performing checks besides the classic check for an unresponsive processor. Examples of the present disclosure may be based on events pattern recognition and may offer a mechanism which may not require software resources on the supervised device yet may still be able to verify the accuracy of the reference clock and detect software malfunctions (due to random or systematic failures). Additionally, the present disclosure may enable the use of independent teams of software developers for the supervised device and watchdog/supervisory device as the checks may be agnostic to the code structure on each device. Furthermore, some examples add a load disconnect function that may be useful when multiple reset retrials fail to fix a malfunctioning device.

As described in the examples below, a high level of SIL may be achieved using an asymmetric topology where the supervised device and the watchdog/supervisory device may be different devices. This approach may provide diversity and reduce total system cost compared to a classic topology where both subsystems are equivalent in terms of processing power. In examples of the present disclosure, the supervisory device may act as an “advanced watchdog” for the supervised device and reset the system or disconnect the load if a malfunction is detected.

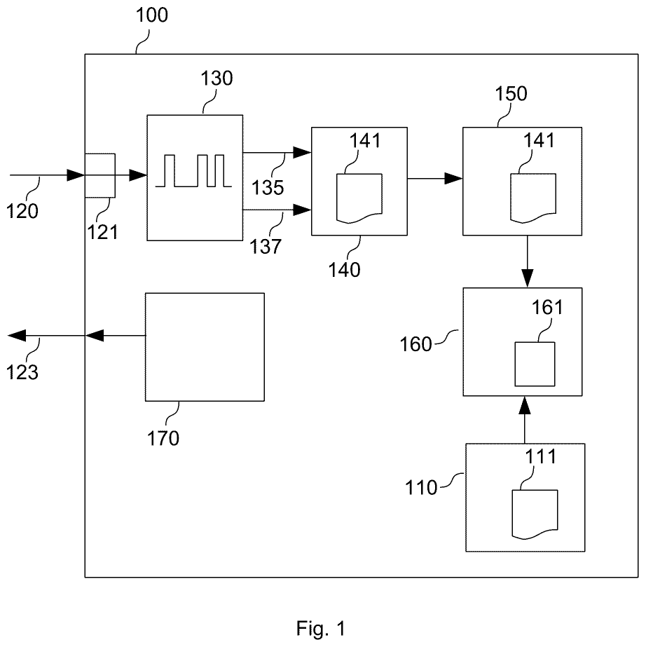

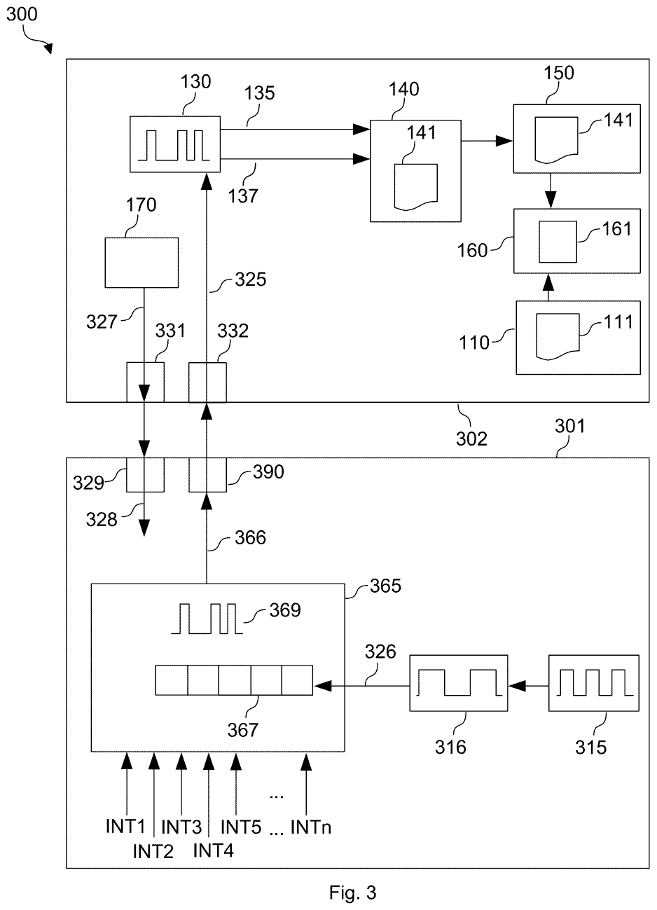

FIG. 1 illustrates an example apparatus 100 for monitoring the operation of a processor. In an example, apparatus 100 may correspond to an electronic device (e.g., second device 302, FIG. 3) configured to monitor the operation of a processor of a separate electronic device (e.g., first device 301, FIG. 3). In the same or different examples, apparatus 100 may include first memory 110. First memory 110 may include one or more storage modules configured to retain data and executable instructions for monitoring the operation of a processor. First memory 110 may include non-volatile memory (e.g., flash, ROM, among others) for persistent storage, and volatile memory (e.g., RAM, DRAM, SRAM, among others) for temporary storage of runtime data and program execution. First memory 110 may be operatively coupled to one or more circuits (e.g., processors, cross correlator 160, among others) and may be accessible via an internal bus or communication interface (not shown). In the same or different examples, first memory 110 may be implemented as a circular buffer.

In the same or different examples, first memory 110 may include program signature pattern 111. In an example, program signature pattern 111 may include data corresponding to a software program to be run on an electronic device other than apparatus 100 (e.g., first device 301, FIG. 3). In the same or different examples, program signature pattern 111 may be considered a “fingerprint” of a software program by including data corresponding to periodical events that occur while the software program is running. In the same or different examples, program signature pattern 111 may include data representing a sequence of system interrupts predicted to be triggered by the software program when run on an electronic device. In the same or different examples, program signature pattern 111 may include data corresponding to a sequence of priority ranked interrupts that occur while a software program is running on electronic device. In the same or different examples, program signature pattern 111 may include data corresponding to a sequence of periodical events such as I/O access, status flag assertion, among others.

In the same or different examples, apparatus 100 may include input pin 121 (for receiving input signal 120) and reset output signal 123. Reset output signal 123 may be coupled to a pin of apparatus 100 (not shown) and configured to transmit data signals.

In the same or different examples, apparatus 100 may include timer module 130. Timer module 130 may be implemented in hardware. In an example, timer module 130 may be coupled to input signal 120. In the same or different examples, timer module 130 may include logic configured to measure elapsed time and capture external events. Timer module 130 may include a counter circuit that increments according to a system clock or prescaled clock input. In addition, timer module 130 may provide an event capture input pin that latches the current counter value when an external signal transition is detected, such as a rising or falling edge. This may allow precise measurement of event timing, such as pulse widths or input signal frequencies, without requiring continuous software polling. In the same or different examples, timer module 130 may be configured to capture a frequency 135 and a captured duty cycle 137 based on input signal 120. In an example, timer module 130 may further generate interrupts in response to capture events, enabling efficient software servicing. Such timer and event capture functionality is available in numerous commercially available microcontrollers. For example, microcontrollers from Microchip Technology Inc., including the PIC32MX family, incorporate Input Capture modules that allow hardware-based timestamping of external events for real-time processing applications.

In the same or different examples, apparatus 100 may include decoder 140. In an example, decoder 140 may be logic configured to determine external program state 141 of an external program based on captured duty cycle 137. In an example, decoder 140 may be implemented in software executing on a processor. In another example, decoder 140 may be implemented in hardware. In another example, decoder 140 may be implemented by (1) software executing on a processor and (2) hardware. In the same or different examples, decoder 140 may determine external program state 141 of an external program according to a pre-defined correlation between captured duty cycle 137 and possible external program states. TABLE 1 provides an example correlation between captured duty cycle 137 and possible external program states.

TABLE 1

| | External Program |
|---|---|
| Duty Cycle | State 141 |
| 0% | State 0 |
| 6.25% | State 1 |
| 12.5% | State 2 |
| 18.75% | State 3 |
| 25% | State 4 |
| 50% | State 5 |
| 75% | State 6 |
| 81.25% | State 7 |
| 87.5% | State 8 |
| 100% | State 9 |

According to the example of TABLE 1, decoder 140 may determine that external program state 141 is State 0 if the captured duty cycle is 0%, that external program state 141 is State 1 if the captured duty cycle is 6.25%, and so on. In an example, States 0-9 may correspond to the state of various system interrupt signals (e.g., system interrupt signals INT1-INTn, FIG. 3) during execution of an external program on an external device.

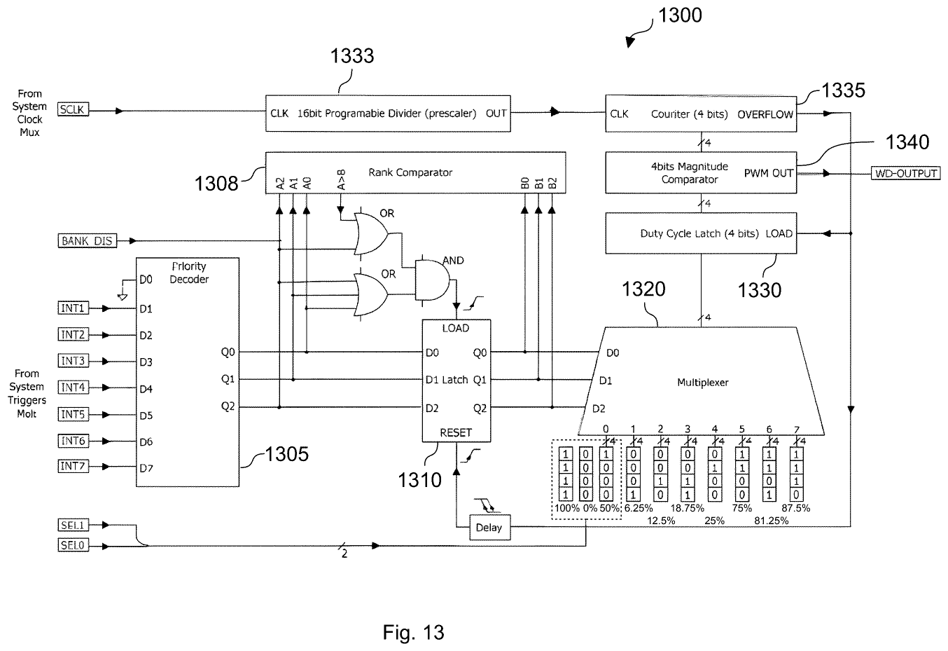

FIG. 13 depicts a block diagram of an example logic 1300 for generating a PWM signal (WD-OUTPUT) having a duty cycle that may correspond to the state of various system interrupt signals during execution of a program on an electronic device. In the example, a continuous rectangular signal (WD-OUTPUT) may be generated having a frequency that may be derived from a system clock domain (SCLK) through programmable clock divider 1333 (prescaler). The continuous rectangular signal (WD-OUTPUT) may be generated having a variable duty cycle correlated to an identifiable sequence of system interrupts (INT1-INT7) which may be triggered between two consecutive PWM cycles. System clock SCLK may act as the clock for clock divider 1333, programmed with number (n), resulting in an output clock with frequency SCLK/n that, in turn, may act as the clock for PWM counter 1335. In the example, frequency SCLK/n may establish a “time granularity” for sampling the state of system interrupts (INT1-INT7) because logic 1300 may result in the duty cycle of PWM signal WD-OUTPUT changing at the end of each cycle of output clock SCLK/n. For example, the duty cycle of PWM signal WD-OUTPUT may depend on the last most important interrupt event that asserts during the current PWM cycle.

Example logic 1300 may include 4-bit PWM counter 1335 (e.g., counting up), 4-bit duty cycle (DC) latch register 1330, and 4-bit magnitude comparator 1340. In the example, the output (PWM OUT) of 4-bit magnitude comparator 1340 may depend on the current value of DC latch register 1330 and PWM counter 1335 where the output (PWM OUT) may be (a) logic high when DC latch register 1330 is greater than or equal to PWM counter 1335 and (b) logic low when DC latch register is less than PWM counter 1335. In the example, when PWM counter 1335 exceeds the maximum value, overflows, and transitions back to zero (0), the overflow signal may cause a new value to be latched into DC latch register 1330. The new value may remain in DC latch register 1330 until the next cycle in which PWM counter 1335 reaches an overflow condition (e.g., counter maximum value). In this manner, a new duty cycle for (PMW OUT) may be established based on the output of multiplexer 1320.

Multiplexer 1320 may have three possible values available on the first multiplexer port (port 0): 0%-0b0000, 50%-0b1000 and 100%-0b1111, which may be selectable with signals SEL1/SEL2. For 0%, WD-OUTPUT may be logic LOW; for 100%, WD-OUTPUT may be logic HIGH; and for 50%, the WD-OUTPUT may be a clock signal with the frequency of SCLK/(n+16) and the duty cycle of 50%. In an example, multiplexer 1320 default state may be port 0, when the signals D0, D1, D2 are all LOW (i.e., no events have caused INT1-INT7 to be asserted). In the default state, multiplexer 1320 output may be HIGH (0b1111), LOW (0b0000), or 0b 1000 resulting in duty cycle of WD-OUTPUT of 100%, 0%, and 50%, respectively.

In an example, seven system interrupts (INT1-INT7) may be available as inputs to priority decoder 1305. Other examples may include more or fewer interrupts, and the choice of which interrupts are available may be programmable. In the examples, the assertion of a system interrupt that is available as input to priority decoder 1305 may change the duty cycle of WD-OUTPUT (PWM OUT) for the next PWM cycle. In some examples, more than one system interrupt available as input to priority decoder 1305 may assert during a PWM cycle. This may cause a race condition because the system interrupts may be asynchronous with respect to latch 1310. Accordingly, logic 1300 may include logic to solve system interrupt race conditions so that the duty cycle of WD-OUTPUT for the next PWM cycle may correspond to a single asserted system interrupt.

FIG. 13 illustrates two examples for solving system interrupt race conditions based on the RANK DIS input signal. When RANK_DIS=1, the order of system interrupts within a PWM cycle may determine the “winner.” In this example, priority decoder 1305 may solve the race with DO (grounded) being the least significant priority and D7 being the most significant priority. In the example, when simultaneous interrupts at the input to priority decoder 1305 are asserted, priority decoder 1305 may output the most significant one. In the same example, transitions on the inputs to priority decoder 1305 may transfer the value to the output of latch 1310 due to the OR logic function between the inputs to latch 1310. Thus, in this example, multiplexer 1320 inputs D0, D1, D2 may be updated with the last most significant interrupt that asserted in the PWM cycle and a duty cycle value sent from multiplexer 1320 to DC latch 1330 may be updated accordingly. Available duty cycles may be values different from 0%, 50%, and 100% as long as the value is quantifiable by the hardware that will eventually decode the PWM signal (e.g., decoder 140, FIG. 1). In the FIG. 13 example, 4-bit DC latch 1330 may allow a duty cycle granularity of 6.25%.

When RANK_DIS=0, the “winning” system interrupt may be the system interrupt with the higher rank regardless of the moment when it was asserted within the PWM cycle. For example, rank comparator 1308 may cause a system interrupt to be loaded into latch 1310 if it has a bigger rank than the current value latched into latch 1310. In an example, rank comparator 1308 may be implemented by a binary magnitude comparator.

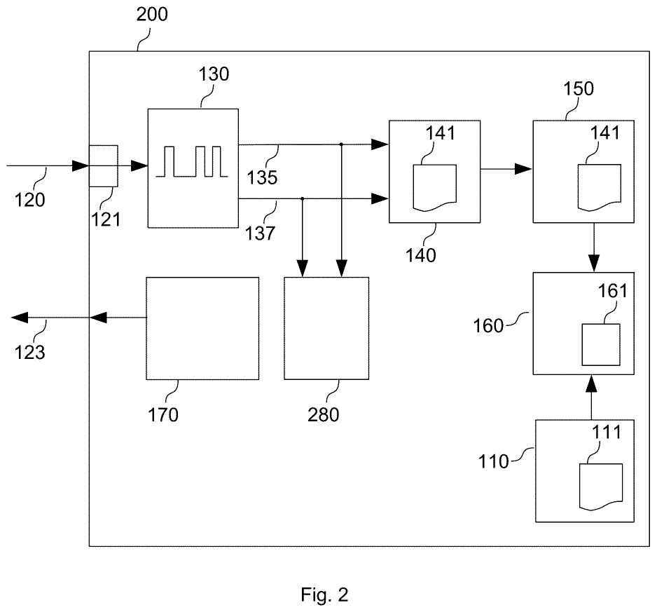

For either value of RANK DIS, a new duty cycle value may be loaded into DC latch 1330 at the end of each PWM cycle (e.g., PWM counter 1335 overflow) and, due to the delayed RESET input on latch 1310, latch 1310 will be reset to 0b000. If no interrupt is asserted during a PWM cycle, the duty cycle will remain unchanged (either 0%, 50%, or 100% based on SEL1/SEL2 when multiplexer 1320 input D0, D1, D2 is 0b000). In an example, the two values 0% and 100% may represent IDLE states which may be used with a traditional external watchdog. Using these values, the WD-OUTPUT may remain LO or HI until a combination of interrupts change the duty cycle and re-initialize the external watchdog. The 50% IDLE value may result in WD-OUTPUT having a 50% duty cycle. This may be used in conjunction with an external watchdog capable of monitoring the supervised device's clock (e.g., clock validator 280, FIG. 2).

In an example, selected system interrupts INT1-INT7 may be from periodical sources of events, triggered by actual software running on the device. Accordingly, logic 1300 may result in a repeatable pattern of the duty cycles of WD-OUTPUT, which may form a software signature for the software running on the device. This software signature may be created without the need for additional code and without delays due to polling of hardware events.

Apparatus 100 may include second memory 150. Second memory 150 may include one or more storage modules configured to store external program state 141. Second memory 150 may include non-volatile memory (e.g., flash, ROM, among others) for persistent storage, and volatile memory (e.g., RAM, DRAM, SRAM, among others) for temporary storage of runtime data and program execution. Second memory 150 may be operatively coupled to one or more circuits (e.g., processors, cross correlator 160, among others) and may be accessible via an internal bus or communication interface (not shown). In the same or different examples, second memory may be implemented as a FIFO having a length that is big enough to store a program signature pattern (e.g., the length of program signature pattern 111).

Apparatus 100 may include cross correlator 160. In an example, cross correlator 160 may be logic configured to determine an external program health score 161 of an external program based on comparing program signature pattern 111 stored in first memory 110 with external program state 141 stored in second memory 150. In an example, cross correlator 160 may be implemented in software executing on a processor. In another example, cross correlator 160 may be implemented in hardware. In another example, cross correlator 160 may be implemented by (1) software executing on a processor and (2) hardware. In the same or different examples, cross correlator 160 may be configured to use a sliding window technique to synchronize program signature pattern 111 stored in first memory 110 and external program state 141 stored in second memory 150.

Apparatus 100 may include reset logic 170. In an example, reset logic 170 may be logic configured to assert reset output signal 123 when external program health score 161 is below a predetermined threshold. In an example, reset logic 170 may be implemented in software executing on a processor. In another example, reset logic 170 may be implemented in hardware. In another example, reset logic 170 may be implemented by (1) software executing on a processor and (2) hardware. In an example, reset logic 170 may include a programmable threshold level register (not illustrated) and may assert reset output signal 123 when external program health score 161 falls below that level. In the same or different examples, reset logic 170 may include a disconnect signal connected to a GPIO pin on apparatus 100 (not illustrated). Reset logic 170 may assert the disconnect signal when multiple resets fail to fix a malfunctioning external device. In the example, the disconnect signal GPIO pin may be connected logic that may put the external device in a safe state by cutting power.

In operation, apparatus 100 may receive input signal 120 over time and determine based on that signal if an external device should be reset (or if the load should be disconnected). For example, input signal 120 may be generated by an external device having logic similar to logic 1300 (FIG. 13) which generates WD-OUTPUT that may encode device state (e.g., system interrupt state) in the duty cycle of WD-OUTPUT while software is running on the external device. Timer module 130 may capture the duty cycle of input signal 120 and may output captured duty cycle 137. Decoder 140 may determine external program state 141 of an external program based on captured duty cycle 137 (e.g., using TABLE 1). External program state 141 may then be stored in second memory 150 which may be a FIFO with the length of program signature pattern 111. First memory 110 may be a circular buffer (e.g., implemented in both software and hardware) and contain program signature pattern 111. Cross correlator 160 may compare the external program state values 141 stored in the FIFO (second memory 150) over time with program signature pattern 111 stored in the circular buffer (first memory 110). Cross correlator 160 may determine external program health score 161 based on the comparison.

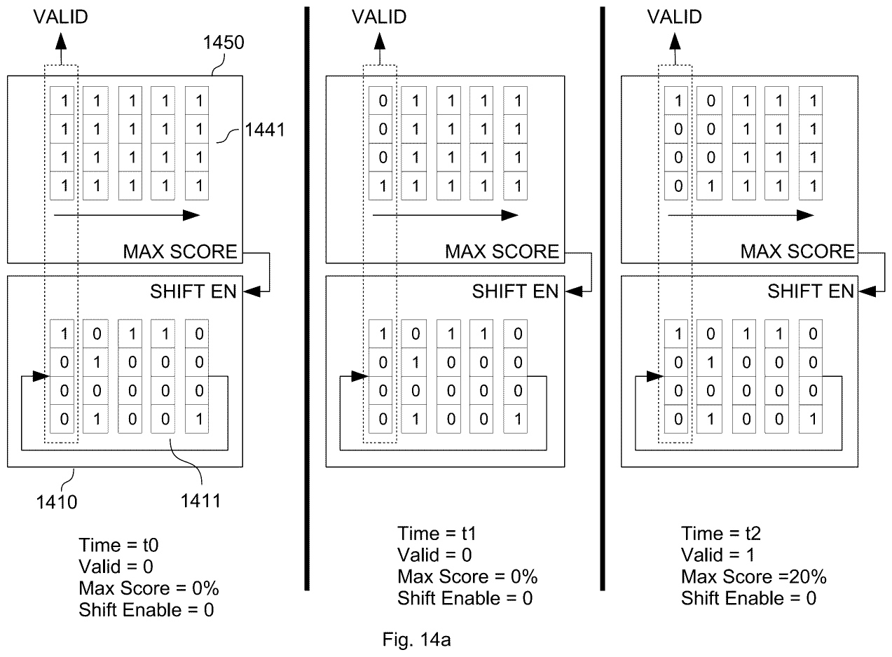

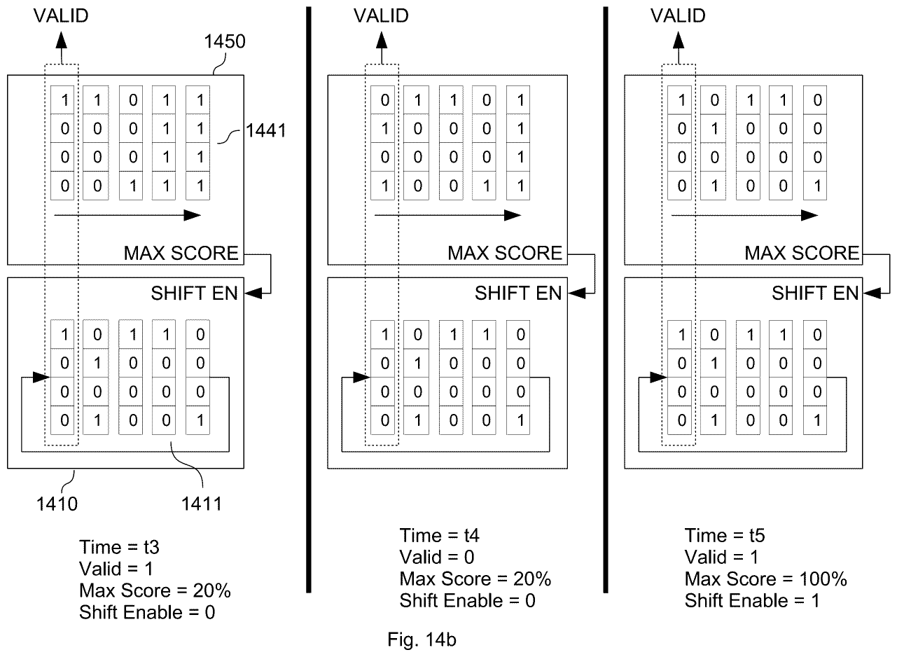

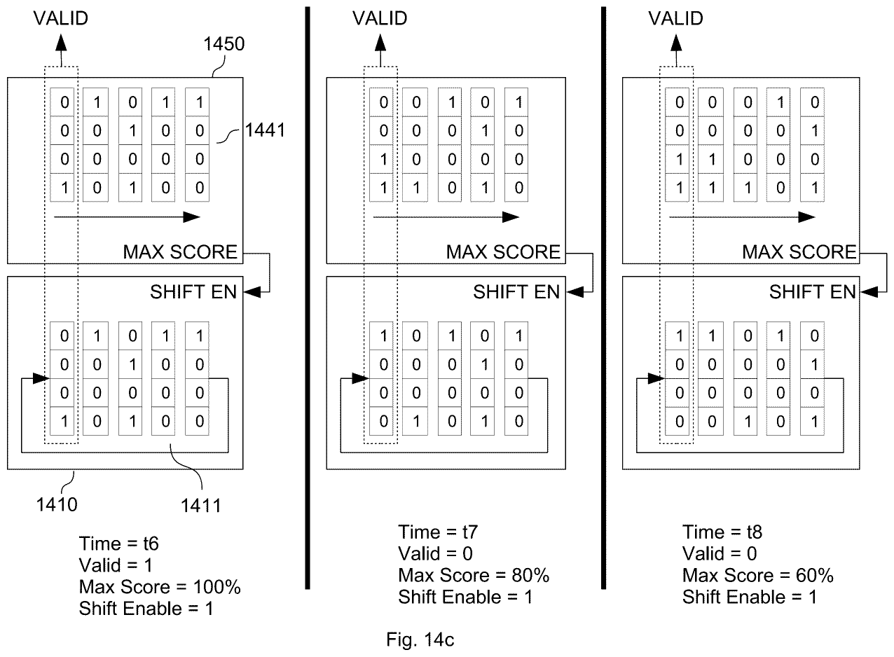

FIGS. 14a-14c illustrate an example of cross correlator 160 (FIG. 1) determining external program health score 161 when an external program state on input signal 120 is generated by an external device having logic 1300 with RANK_DIS=0 (i.e., the “winning” system interrupt may be the system interrupt with the higher rank regardless of the moment when it was asserted within the PWM cycle). FIG. 14a includes second memory 1450 as a FIFO storing external program state values 1441 and first memory 1410 as a circular buffer storing program signature pattern 1411. FIG. 14a illustrates exemplary states of these memories from time t0-t2. FIG. 14b illustrates exemplary states of these memories from time t3-t5. FIG. 14c illustrates exemplary states of these memories from time t6-t8.

In the example, program signature pattern 1411 includes five repeating states. Other program signature patterns may include more or fewer states. The length of second memory 1450 FIFO may be configured to be the same as the length of program signature pattern 1411. A comparison between the first element in the FIFO (second memory 1450) and the first element of the circular buffer (first memory 1410) may provide the output validity “VALID”.

At time t0, the FIFO (second memory 1450) may be initialized with invalid word symbols 0b1111 (e.g., corresponding to 100% duty cycle). In other examples, the FIFO may be initialized with invalid word symbols 0b0000 (e.g., corresponding to 0% duty cycle). At time to, circular buffer (first memory 1410) may be initialized with program signature pattern 1411. In an example, program signature pattern 1411 may be loaded from a different memory (not shown) where it may be stored in a compressed format. In that case, program signature pattern 1411 may be decompressed so that all pattern values are serialized.

In operation, cross correlator 160 may compare each instance (position) of the circular buffer (first memory 1410) to each instance (position) of the FIFO (second memory 1450) and based on the number of matching positions, may determine external program health score 161. A 100% pattern match may indicate a maximum score (i.e., the maximum score may be equal to the size of the circular buffer). At initialization time (t0), external program health score 161 may be zero. Once data is captured on input signal 120 and external program state values 1441 are stored in the FIFO (second memory 1450), the FIFO may be slowly filled and external program health score 161 may start to vary based on matching positions.

For example, at time t1, the first external program state value (0b0001) may be written into the FIFO resulting in VALID=0 (first entries do not match), MAX_SCORE=0% (no matching entries), and SHIFT_ENABLE=0 (MAX_SCORE has not been reached).

At time t2, the second external program state value (0b1000) may be written into the FIFO resulting in VALID=1 (first entries match), MAX_SCORE=20% (1/5 matching entries), and SHIFT_ENABLE=0 (MAX_SCORE has not been reached).

At time t3, the third external program state value (0b1000) may be written into the FIFO resulting in VALID=1 (first entries match), MAX_SCORE=20% (1/5 matching entries), and SHIFT_ENABLE=0 (MAX_SCORE has not been reached).

At time t4, the fourth external program state value (0b0101) may be written into the FIFO resulting in VALID=0 (first entries do not match), MAX_SCORE=20% (1/5 matching entries), and SHIFT_ENABLE=0 (MAX_SCORE has not been reached).

At time t5, the fifth external program state value (0b1000) may be written into the FIFO resulting in VALID=1 (first entries match), MAX_SCORE=100% (5/5 matching entries), and SHIFT ENABLE=1 (MAX_SCORE has been reached). In an example, once the maximum score has been achieved, the SHIFT_ENABLE signal may stay asserted so that the circular buffer (first memory 1410) may start moving synchronously with the FIFO clock, and the matching between the FIFO and the circular buffer positions may be maintained (even if the score decreases due to an input error). This technique used to match patterns may be referred to as a Sliding Window.

Accordingly, at time t6, the sixth external program state value (0b0001) may be written into the FIFO resulting in VALID=1 (first entries match), MAX_SCORE=100% (5/5 matching entries), and SHIFT_ENABLE=1 (MAX_SCORE previously reached). Note that the circular buffer advanced compared to time t5 (i.e., moving synchronously with the FIFO).

At time t7, the seventh external program state value (0b0011) may be written into the FIFO resulting in VALID=0 (first entries do not match), MAX_SCORE=80% (4/5 matching entries), and SHIFT_ENABLE=1 (MAX_SCORE previously reached).

At time t8, the eighth external program state value (0b0011) may be written into the FIFO resulting in VALID=0 (first entries do not match), MAX_SCORE=60% (3/5 matching entries), and SHIFT_ENABLE=1 (MAX_SCORE previously reached).

As MAX_SCORE may indicate the current number of matching positions and the VALID signal may indicate the first position matching, these two indicators may be used to decide a resynchronization threshold for cross correlator 160. For example, cross correlator 160 may be reset when a minimum threshold is reached. In an example where 70% is a minimum threshold, cross correlator 160 may not be reset at time t7 because the MAX_SCORE is 80% whereas cross correlator 160 may be reset at time t8 because the MAX_SCORE is 60%.

In operation, cross correlator 160 may determine external program health score 161 based on the value of MAX_SCORE over time. In an example, external program health score 161 may reflect the current MAX_SCORE. In another example, external program health score 161 may reflect a running average of MAX_SCORE over the past N clock cycles. In other examples, external program health score 161 may reflect other suitable functions using MAX_SCORE, VALID, or MAX_SCORE and VALID (instant values or values over time).

In operation, reset logic 170 may assert reset output signal 123 when external program health score 161 falls below a predetermined threshold.

FIG. 2 illustrates an example apparatus 200 for monitoring the operation of a processor. In an example, apparatus 200 may include the same blocks as in FIG. 1 with the addition of clock validator 280. Clock validator 280 may be software configured to validate, based on frequency 135 and captured duty cycle 137 over time, a supervised clock signal from an electronic device other than apparatus 200 (e.g., first device 301, FIG. 3).

In operation, clock validator 280 may evaluate, continuously cycle-by-cycle, the health of the clock on the external device that is generating input signal 120. In an example, clock validator 280 may perform this evaluation based on its own clock reference timing. In the same or different examples, by knowing (a) the PWM prescaler setting (e.g., system clock divider 316, FIG. 3) on the external device, (b) the frequency of the system clock of the external device, and (c) the frequency of a reference clock in apparatus 200, clock validator 280 may estimate any clock deviation between apparatus 200 and the external device that is generating input signal 120 and may determine a fault state if the deviation exceeds a threshold or when the condition persists in time. In such a fault state is determined, reset logic 170 may assert reset output signal 123, which may cause a reset of the external device.

FIG. 3 illustrates an example system 300 for monitoring the operation of a processor. In an example, system 300 may include first device 301 (monitored/supervised device) and second device 302 (watchdog/supervisor device). In an example, first device 301 may include system clock 315, system clock divider 316, reset input pin 329 (for receiving reset input 328), watchdog output pin 390, pulse width modulation (PWM) circuit 365, and system interrupt signals INT1-INTn. PWM circuit 365 may include counter 367 and may generate pulse width modulated (PWM) signal 366 having duty cycle 369.

System clock 315 may be a system clock signal for synchronizing digital logic. System clock 315 may be driven by an external device or internally generated based on a reference signal from an external crystal oscillator, resonator, or on-chip RC oscillator. System clock 315 may be distributed to processor cores, memory interfaces, and peripheral subsystems within first device 301 to coordinate operation.

System clock divider 316 may be a circuit configured to generate an output clock signal at a frequency that is an integer fraction of system clock 315. System clock divider 316 may include a counter or toggle flip-flop chain that receives system clock 315 as an input and produces divided system clock 326 by counting cycles of the input system clock 315. For example, a divide-by-2 circuit may toggle its output state on each rising edge of the input clock, thereby producing a square wave at one-half the input frequency. More generally, system clock divider 316 may be programmable to provide a range of division ratios, such as divide-by-N, by selectively resetting the counter after a predetermined number of input clock cycles.

Reset input pin 329 may be configured to receive reset input 328 that may cause first device 301 to be initialized into a known operating state. Reset input 328 may be coupled to control logic that, in response to an asserted reset condition, clears one or more registers, counters, or state machines within first device 301. As a result, first device 301 may be placed into a predetermined default configuration from which normal operation may subsequently begin. Reset input 328 may be configured to respond to an external hardware signal, such as a low level on a dedicated reset pin, or to an internally generated condition, such as a power-on reset event. In certain examples, reset input 328 may further propagate a synchronous reset signal throughout first device 301 to ensure all subsystems transition to the known state in a coordinated manner.

Watchdog output pin 390 may be configured to provide PWM signal 366 for driving an external load. Watchdog output pin 390 may be coupled to driver circuitry that receives PWM signal 366 generated by PWM circuit 365. The driver circuitry may buffer and condition PWM signal 366 to provide sufficient current and voltage levels for external interfacing.

PWM circuit 365 may be any circuit sufficient to generate an output signal (PWM signal 366) having controllable duty cycle 369. In an example, PWM signal 366 may include counter 367 configured to be clocked by divided system clock 326. In the same or different examples, counter 367 may increment in response to divided system clock 326 and a comparator that compares the counter value to a stored threshold value. When the counter value is less than the threshold value, PWM circuit 365 may assert PWM signal 366, and when the counter value is greater than or equal to the threshold value, PWM circuit 365 may deassert PWM signal 366. By adjusting the threshold value, duty cycle 369 of PWM signal 366 may be varied while maintaining a constant period defined by counter 367. In an example, duty cycle 369 may be configured to encode the plurality of system interrupt signals INT1-INTn during execution of an application program (e.g., TABLE 1). In the same or different examples, duty cycle 369 may be configured to encode the plurality of system interrupt signals INT1-INTn based on a priority ranking of the plurality of system interrupt signals, as explained above in describing FIG. 13. In the same or different examples, PWM circuit 365 may update duty cycle 369 when counter 367 reaches a maximum value.

In an example, microcontrollers offered by Microchip Technology Inc., such as members of the PIC32 family, include PWM modules that implement hardware-based PWM generation that may be suitable for use according to this disclosure.

Counter 367 may be any circuit suitable for generating a count value in response to an input signal (e.g., divided system clock 326). Counter 367 may increment or decrement the count value based on transitions of a clock or event input (e.g., divided system clock 326) and may store the current count in one or more registers. Counter 367 may be programmable to operate in different modes, such as free-running, up-counting, down-counting, or up/down counting, and may generate an output when the count reaches a predetermined terminal value.

System interrupt signals INT1, INT2, INT3, INT4, INT5, . . . . INTn may be any signals configured to indicate a system interrupt that may suspend normal program execution in first device 301 and redirect processing to an interrupt service routine. Interrupt signals INT1-INTn may originate from internal modules (e.g., timers, communication peripherals, memory controllers, among others) or from external sources coupled to dedicated interrupt input pins.

Second device 302 may act as a watchdog/supervisor device and include the same blocks as in FIG. 1 (i.e., 110, 111, 130, 135, 137, 140, 141, 150, 160, 161, 170), reset output pin 331 coupled to reset signal 327 (which may be similar to reset output signal 123), and watchdog input signal 325 (which may be similar to input signal 120). In an example, watchdog output pin 390 of first device 301 may be coupled to watchdog input pin 332 of second device 302. In the same or different examples, reset output pin 331 of second device 302 may be coupled to reset input pin 329 of first device 301.

In operation, first device 301 may include a processor that executes software (not shown). One or more system interrupt signals INT1-INTn may trigger (assert) during software execution on first device 301. PWM circuit 365 may generate PWM signal 366, encoding the state of system interrupt signals in duty cycle 369 of PWM signal 366, for example, according to the encoding described with respect to FIG. 13. PMW signal 366 may be provided to second device 302 (via watchdog output pin 390 and watchdog input signal 325). Second device 302 may determine if first device 301 should be reset (or if the load should be disconnected), for example, in the manner described with respect to apparatus 100 (FIG. 1) and apparatus 200 (FIG. 2). In an example, reset logic 170 may assert reset output 327 when external program health score 161 falls below a predetermined threshold, and reset output 327 may be received as reset input 328 of first device 301. In response to an asserted reset condition, logic on first device 301 may clear one or more registers, counters, or state machines. As a result, first device 301 may be placed into a predetermined default configuration from which normal operation may subsequently begin.

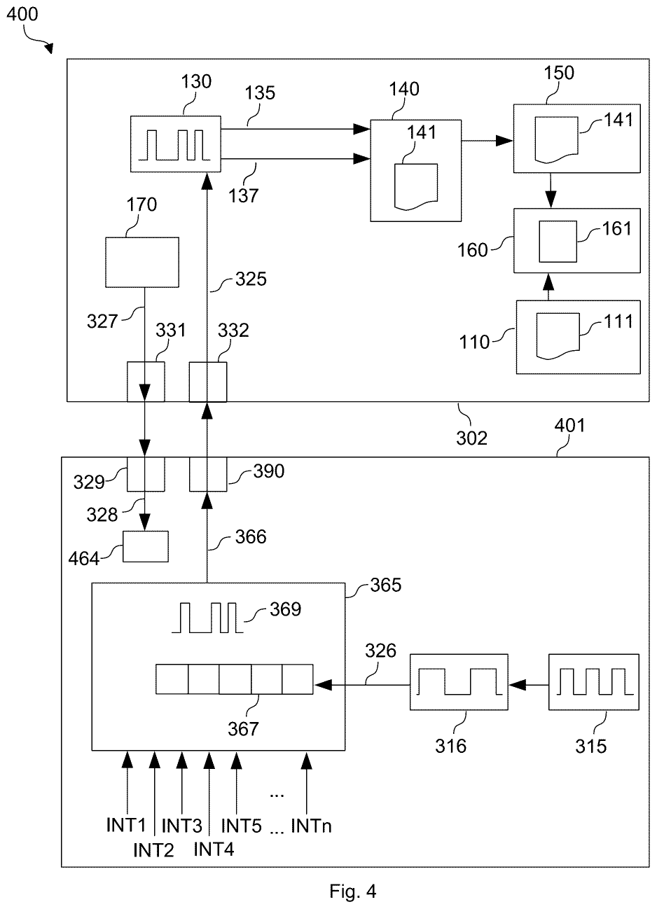

FIG. 4 illustrates an example system 400 for monitoring the operation of a processor. In an example, system 400 may include the same blocks as in FIG. 3 with the addition of reset circuit 464 in first device 401. Reset circuit 464 may be configured to, in response to an asserted reset condition (e.g., reset input 328 asserted), clear one or more registers, counters, or state machines within first device 301. As a result, first device 301 may be placed into a predetermined default configuration from which normal operation may subsequently begin. In certain examples, reset circuit 464 may further propagate a synchronous reset signal throughout first device 301 to ensure all subsystems transition to the known state in a coordinated manner.

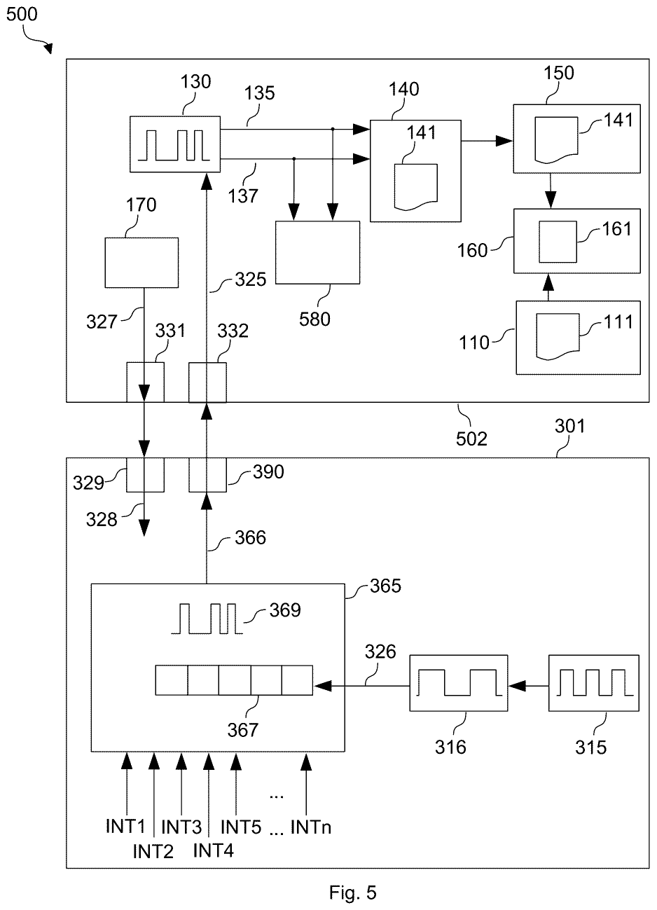

FIG. 5 illustrates an example system 500 for monitoring the operation of a processor. In an example, system 500 may include the same blocks as in FIG. 3 with the addition of clock validator 580 in second device 502. Clock validator 580 may be software configured to validate, based on frequency 135 and captured duty cycle 137 over time, a supervised clock signal (e.g., divided system clock 326, system clock 315) from first device 301.

In operation, clock validator 580 may evaluate, continuously cycle-by-cycle, the health of system clock 315 on first device 301. In an example, clock validator 580 may perform this evaluation based on its own clock reference timing. In the same or different examples, by knowing (a) the PWM prescaler setting (e.g., system clock divider 316 of first device 301), (b) the frequency of system clock 315 on first device 301, and (c) the frequency of a reference clock in second device 302 (not shown), clock validator 580 may estimate any clock deviation between second device 302 and the first device 301 and may determine a fault state if the deviation exceeds a threshold or when the condition persists in time. In such a fault state is determined, reset logic 170 may assert reset output 327, which may cause a reset of first device 301.

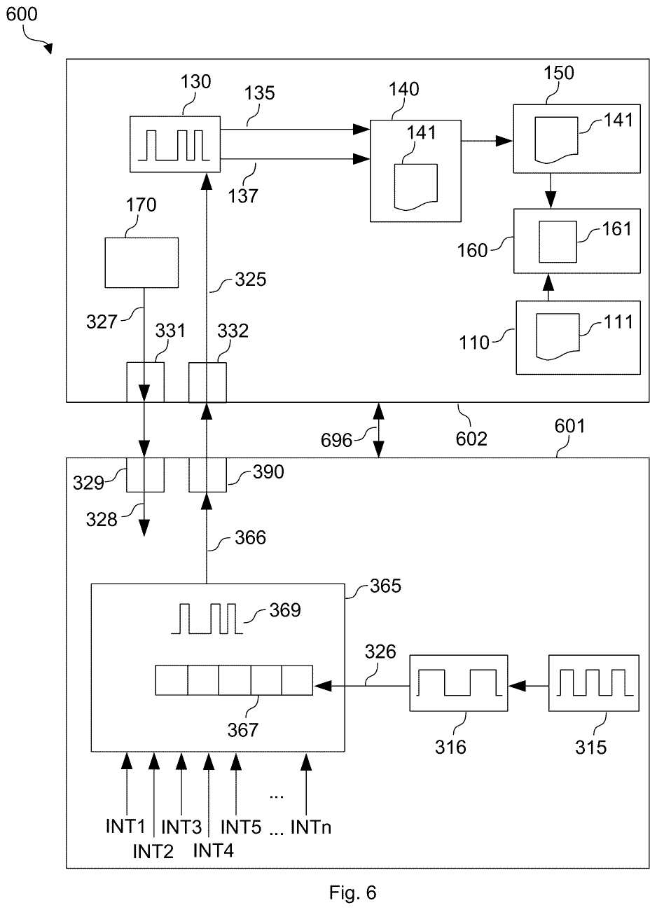

FIG. 6 illustrates an example system 600 for monitoring the operation of a processor. In an example, system 600 may include the same blocks as in FIG. 3 with the addition of bidirectional and asynchronous serial data connection 696 between first device 601 and second device 602. Bidirectional and asynchronous serial data connection 696 may be configured to facilitate data transfer between first device 601 and second device 602. Serial data connection 696 may enable communication without requiring a shared clock signal, instead relying on agreed-upon baud rates and framing protocols such as start and stop bits to delineate transmitted data. The bidirectional configuration may allow first device 601 to transmit data to second device 602 and second device 602 to transmit data to first device 601 over the same communication medium. In certain examples, serial data connection 696 may be realized using a pair of transceivers, buffer circuitry, or universal asynchronous receiver-transmitter (UART) modules integrated into the respective devices. The asynchronous and bidirectional nature of the connection may provide a flexible and efficient communication path that supports real-time data exchange between devices without requiring tight clock synchronization.

In operation, serial data connection 696 may enable capture and logging of supervised system data within the scope of pattern detection and best possible parameter settings related to the current software running on the first device 301.

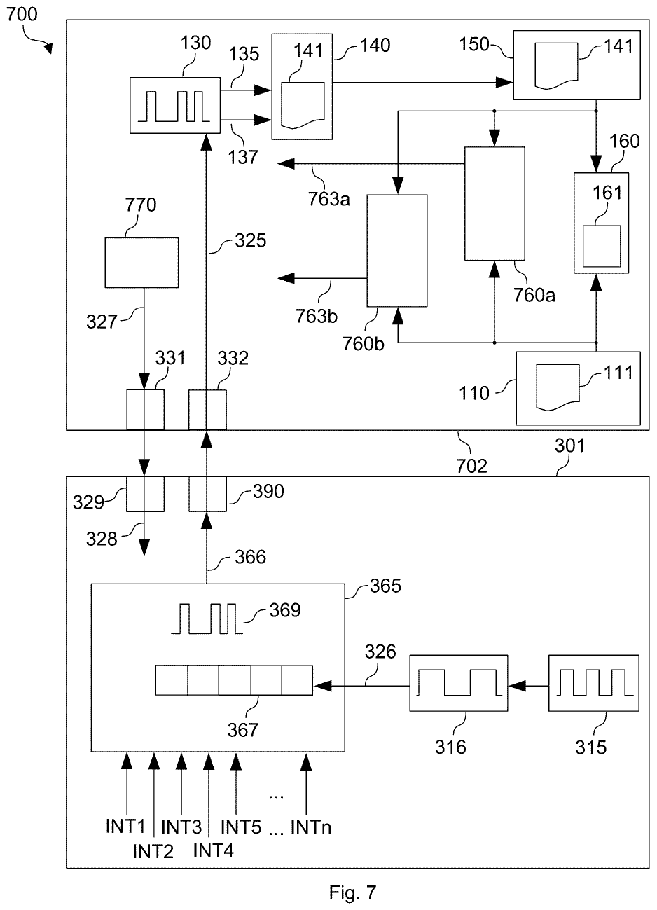

FIG. 7 illustrates an example system 700 for monitoring the operation of a processor. In an example, system 700 may include the same blocks as in FIG. 3 with the addition of first additional cross correlator 760a, second additional cross correlator 760b, and reset logic 770 in second device 702. First additional cross correlator 760a may be logic configured to generate first pattern valid signal 763a based on comparing a first value from program signature pattern 111 stored in first memory 110 with external program state 151 stored in second memory 150. Second additional cross correlator 760b may be logic configured to generate second pattern valid signal 763b based on comparing a second value from program signature pattern 111 stored in first memory 110 with external program state 151 stored in second memory 150. In the same or different examples, first and second additional cross correlators 760a-b may be implemented in software executing on a processor. In another example, first and second additional cross correlators 760a-b may be implemented in hardware. In another example, first and second additional cross correlators 760a-b may be implemented by (1) software executing on a processor and (2) hardware. In the same or different examples, reset logic 770 may be configured to assert reset output 327 based on external program health score 161, first pattern valid signal 763a, and second pattern value signal 763b.

In operation, additional cross correlators 760a-b may be used when first device 301 encodes system interrupt signals INT1-INTn into duty cycle 369 of PWM signal 366 using logic 1300 (FIG. 13) with RANK_DIS=1. In this case, system interrupt state on first device 301 may not be predicted exactly from some PWM cycles but it may be within a set of possible values (e.g., due to race conditions between two interrupts that assert during a PWM cycle). Thus, multiple possible values for system interrupt state in a single PWM cycle may be included in program signature pattern 111 stored in first memory 110. Additional cross correlators 760a-b may allow for pattern matching where such multiple possibilities exists for a certain spot in the pattern chain.

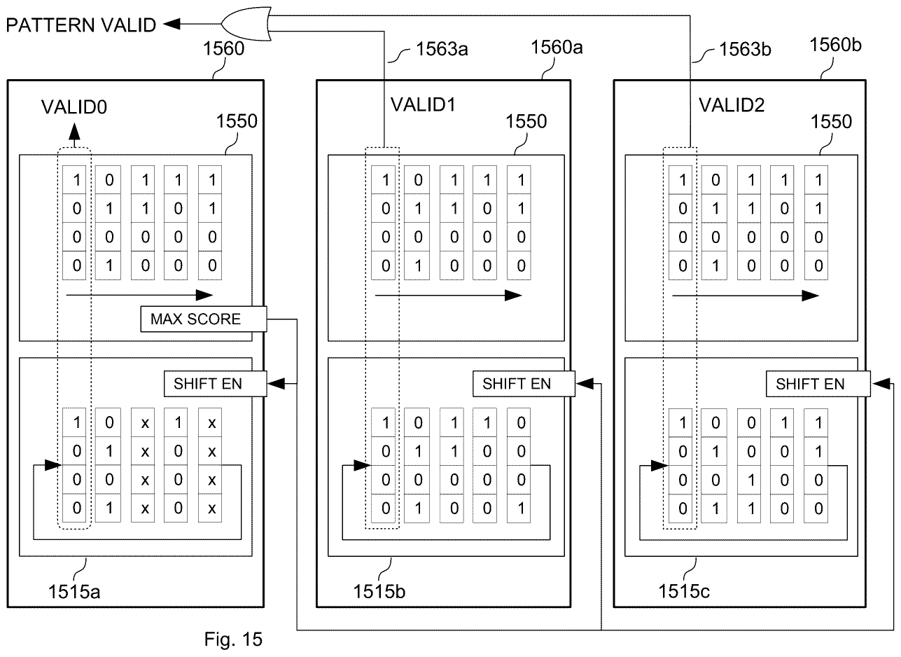

Cross correlators 760, 760a, and 760b may operate similar to cross correlator 160, as illustrated in FIGS. 14a-c, with differences illustrated in FIG. 15. FIG. 15 includes cross correlator 1560, first additional cross correlator 1560a, and second additional cross correlator 1560b. Cross correlators 1560, 1560a, 1560b may be implemented in software executing on a processor. In another example, cross correlators 1560, 1560a, 1560b may be implemented in hardware. In another example, cross correlators 1560, 1560a, 1560b may be implemented by (1) software executing on a processor and (2) hardware.

In an example, each cross correlator 1560, 1560a, 1560b may include its own FIFO 1550 for storing external program state 141. In other examples, each cross correlator 1560, 1560a, 1560b may be coupled to a shared FIFO 1550. In both examples, data in FIFO 1550 may be the same for each cross correlator 1560, 1560a, 1560b because external program state 141 may be saved as it is received from first device 310 and decoded by decoder 140 in second device 702.

Cross correlator 1560 may include circular buffer 1515, first additional cross correlator 1560a may include first additional circular buffer 1515a, and second additional cross correlator 1560b may include second additional circular buffer 1515a. In an example, circular buffers 1515, 1515a, and 1515b may be implemented by hardware and software, in memory elements other than first memory 110. In an example, entries in circular buffer 1515 that depicted as 0bxxxx may indicate a probabilistic position in program signature pattern 111 stored in first memory 110. A probabilistic position may indicate a PWM cycle where more than one state of system interrupts (e.g., INT1-INTn) may be possible due to a race condition when more than one interrupt is asserted in a PWM cycle and RANK_DIS=1 (FIG. 13). Cross correlator 1560 may load an invalid value (e.g., 0b0000 or 0b1111) into positions in circular buffer 1515 that indicate a probabilistic position, and those positions may be excluded from consideration in determining the score MAX_SCORE.

In an example, for each probabilistic position, first additional cross correlator 1560a may load a first probabilistic value (within the possible range of values) into first additional circular buffer 1515a, and second additional cross correlator 1560b may load a second probabilistic value (within the possible range of values) into second additional circular buffer 1515a. In this example, there may be two probabilistic possibilities, and the number of additional cross correlators may be two (i.e., first additional cross correlator 1560a, and second additional cross correlator 1560b). In other examples, there may be more than two probabilistic possibilities and more than two additional cross correlators. For example, for a 4-bit duty cycle encoding, up to eight additional cross correlators may be used. In an example where the number of additional cross correlators is equal to the maximum number of probabilistic possibilities, if the number of possible states for a particular PWM cycle is less than the number of additional cross correlators, the unneeded additional cross correlators may be loaded with invalid values (e.g., 0b0000 or 0b1111) for that PWM cycle. Thus, assuming the received PWM signal is healthy, at least one of the additional cross correlators will have a valid output (e.g., VALID1 or VALID2 asserted), resulting in PATTERN_VALID asserting (based on the OR function).

In the FIG. 15 example, cross correlator 1560 may be used to calculate the score (MAX_SCORE) and decide when the data in FIFO 1550 becomes synchronous with circular buffer 1515 so that the circular buffer may begin shifting. MAX_SCORE may be the total number of pattern slots (e.g., five in the illustrated example) less the number of slots with probabilities (e.g., two in the illustrated example). Thus, MAX_SCORE may be 100% when three slots in circular buffer 1515 match the corresponding three slots in FIFO 1550. In the same or different examples, VALID0 in cross correlator 1560 may not be used other than in determining when to start circular buffer shifting. In the example, cross correlator 1560 may provide the SHIFT_EN signal that is used to shift each of circular buffers 1515, 1515a, and 1515b.

As MAX_SCORE may indicate the current number of matching positions and the PATTERN_VALID signal may indicate the first position matching, these two indicators may be used to decide a resynchronization threshold for cross correlators 1560, 1560a, 1560b. For example, cross correlator 1560 may be reset when a minimum threshold is reached.

In operation, cross correlator 1560 may determine external program health score 161 based on the value of MAX_SCORE over time. In an example, external program health score 161 may reflect the current MAX_SCORE. In another example, external program health score 161 may reflect a running average of MAX_SCORE over the past N clock cycles. In other examples, external program health score 161 may reflect other suitable functions using MAX_SCORE, PATTERN_VALID, or MAX_SCORE and PATTERN_VALID (instant values or values over time).

In operation, reset logic 770 may assert reset output 327 when external program health score 161 falls below a predetermined threshold.

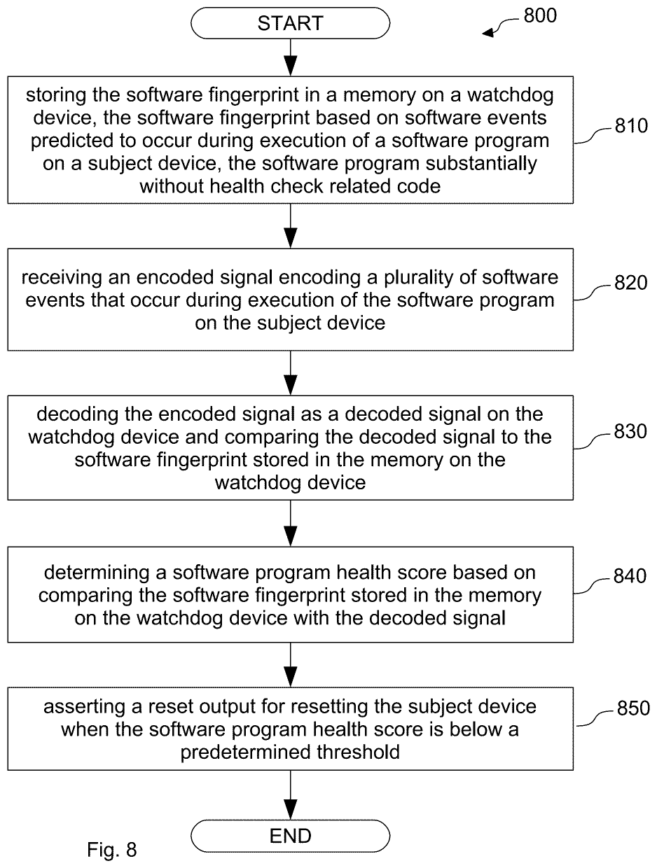

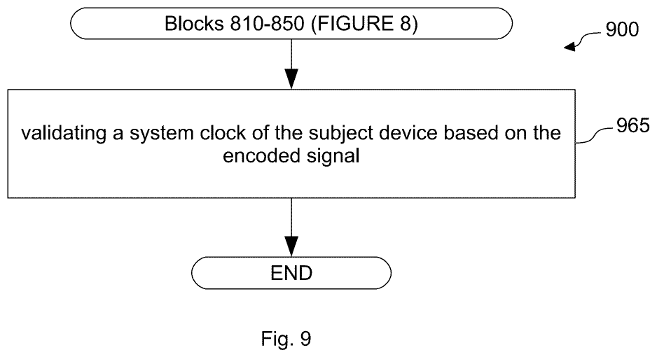

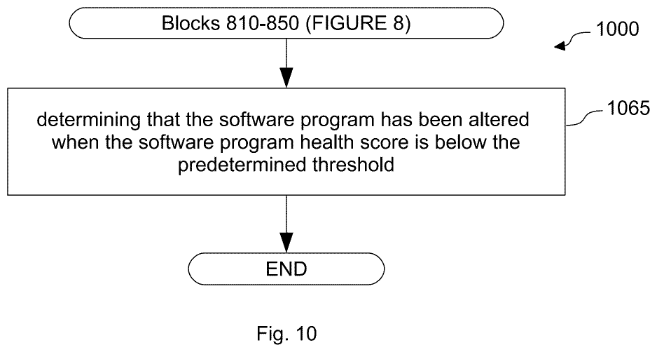

FIG. 8 illustrates a flow chart of an example method 800 for monitoring the operation of a processor. According to one example, method 800 may begin at block 810. The initialization point for method 800 and the order of blocks 810 through 850 may vary depending on implementation.

At block 810, a software fingerprint based on software events predicted to occur during execution of a software program on a subject device may be stored in a memory on a watchdog device, the software program substantially without health check related code. In an example, the software events predicted to occur may include system interrupt events and the software fingerprint may be based on a priority ranking of the system interrupt events. At block 820, an encoded signal may be received, the encoded signal encoding a plurality of software events that occur during execution of the software program on the subject device. At block 830, the encoded signal may be decoded as a decoded signal on the watchdog device and the decoded signal may be compared to the software fingerprint stored in the memory on the watchdog device. At block 840, a software program health score may be determined based on comparing the software fingerprint stored in the memory on the watchdog device with the decoded signal. In an example, the comparing the software fingerprint stored in the memory on the watchdog device with the decoded signal may include using a sliding window technique to synchronize the software fingerprint stored in the memory on the watchdog device with the decoded signal. In the same or different examples, determining the software program health score may be based on artificial intelligence inferencing. For example, TinyML inferencing code can run properly on an 8-bit processor with good results. At block 850, a reset output may be asserted for resetting the subject device when the software program health score is below a predetermined threshold.

Although FIG. 8 discloses a particular number of operations related to method 800, method 800 may be executed with greater or fewer operations than those depicted in FIG. 8. For example, FIGS. 9-10 provide examples of additional operations that may be performed. In addition, although FIG. 8 discloses a certain order of operations to be taken with respect to method 800, the operations comprising method 800 may be completed in any suitable order.

FIG. 9 illustrates a flow chart of an example method 900 for monitoring the operation of a processor. According to one example, method 900 may begin with blocks 810-850 (FIG. 8) and then proceed to block 965. At block 965, a system clock of the subject device may be validated based on the encoded signal.

FIG. 10 illustrates a flow chart of an example method 1000 for monitoring the operation of a processor. According to one example, method 1000 may begin with blocks 810-850 (FIG. 8) and then proceed to block 1065. At block 1065, it may be determined that the software program has been altered when the software program health score is below the predetermined threshold.

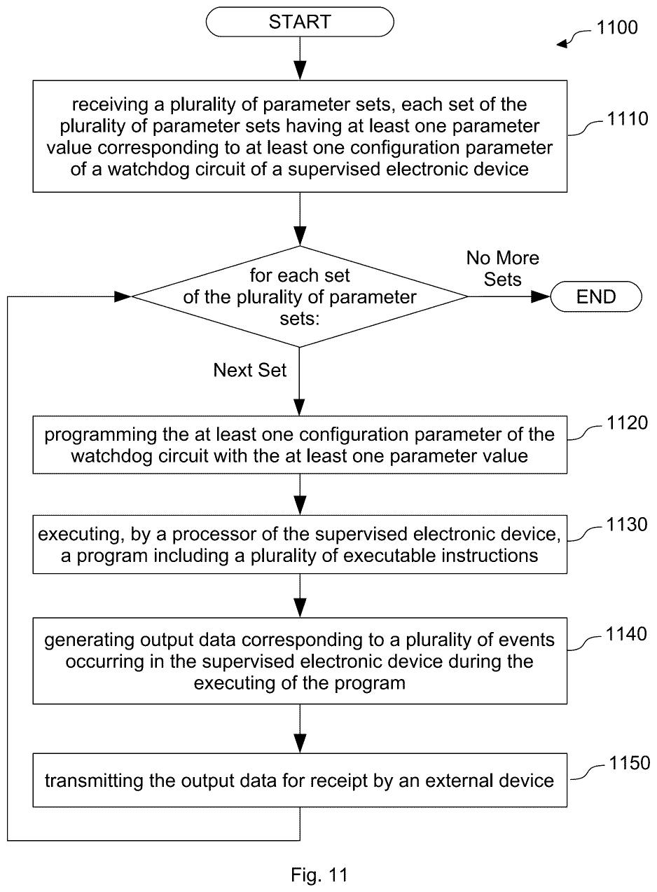

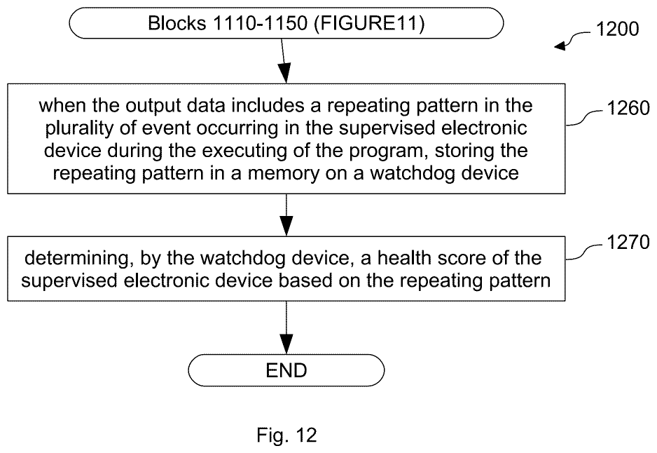

FIG. 11 illustrates a flow chart of an example method 1100 for determining a signature pattern for monitoring the operation of a processor. According to one example, method 1100 may begin at block 1110. The initialization point for method 1100 and the order of blocks 1110 through 1150 may vary depending on implementation.

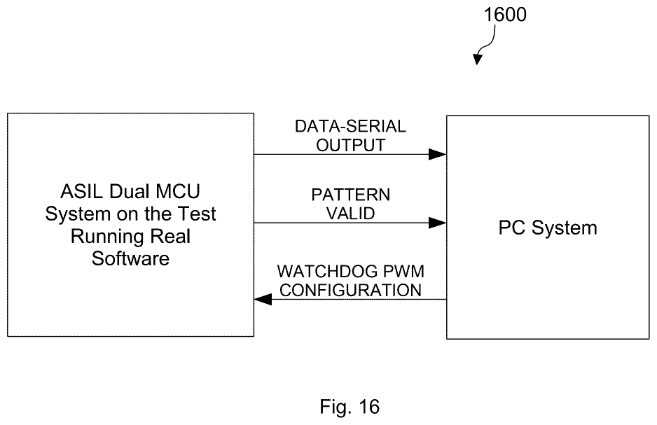

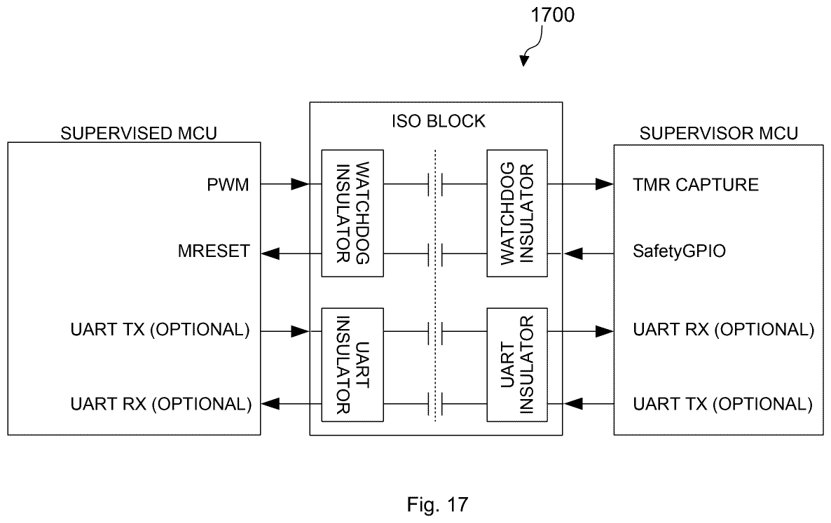

At block 1110, a plurality of parameter sets may be received, each set of the plurality of parameter sets having at least one parameter value corresponding to at least one configuration parameter of a watchdog circuit of a supervised electronic device. (FIGS. 16 and 17 and related descriptions, below, provide examples of parameter sets according to the present disclosure.) In an example, the at least one configuration parameter of the watchdog circuit may include a clock divisor parameter.

Blocks 1120-1150 may be performed for each set of the plurality of parameter sets until there are no more sets in the plurality of parameter sets. At block 1120, the at least one configuration parameter of the watchdog circuit may be programmed with the at least one parameter value. For example, a prescaler value may be programmed to a clock divider 1333 configuration parameter of the watchdog circuit. At block 1130, a program including a plurality of executable instructions may be executed by a processor of the supervised electronic device.

At block 1140, output data corresponding to a plurality of events occurring in the supervised electronic device may be generated during the executing of the program. For example, output data may be generated as PWM signal 366. In an example, the plurality of events occurring in the supervised electronic device during the executing of the program may include a plurality of system interrupt events (INT1-INTn, FIG. 3) occurring in the supervised electronic device during the executing of the program. In the same or different examples, the plurality of system interrupt events may be included in the output data based on a priority ranking (e.g., RANK_DIS=0, FIG. 13) of the system interrupt events occurring in the supervised electronic device during the executing of the program. In the same or different examples, the output data may be generated based on sampling the plurality of system interrupt events at a frequency based at least on the clock divisor parameter. At block 1150, the output data may be transmitted for receipt by an external device (e.g., PWM signal 366).

Although FIG. 11 discloses a particular number of operations related to method 1100, method 1100 may be executed with greater or fewer operations than those depicted in FIG. 11. For example, FIG. 12 provides an example of additional operations that may be performed. In addition, although FIG. 11 discloses a certain order of operations to be taken with respect to method 1100, the operations comprising method 1100 may be completed in any suitable order.

FIG. 12 illustrates a flow chart of an example method 1200 for determining a signature pattern for monitoring the operation of a processor. According to one example, method 1200 may begin with blocks 1110-1150 (FIG. 11) and then proceed to block 1260. At block 1260, when the output data includes a repeating pattern in the plurality of events occurring in the supervised electronic device during the executing of the program, storing the repeating pattern in a memory on a watchdog device. At block 1270, the watchdog device may determine a health score of the supervised electronic device based on the repeating pattern.

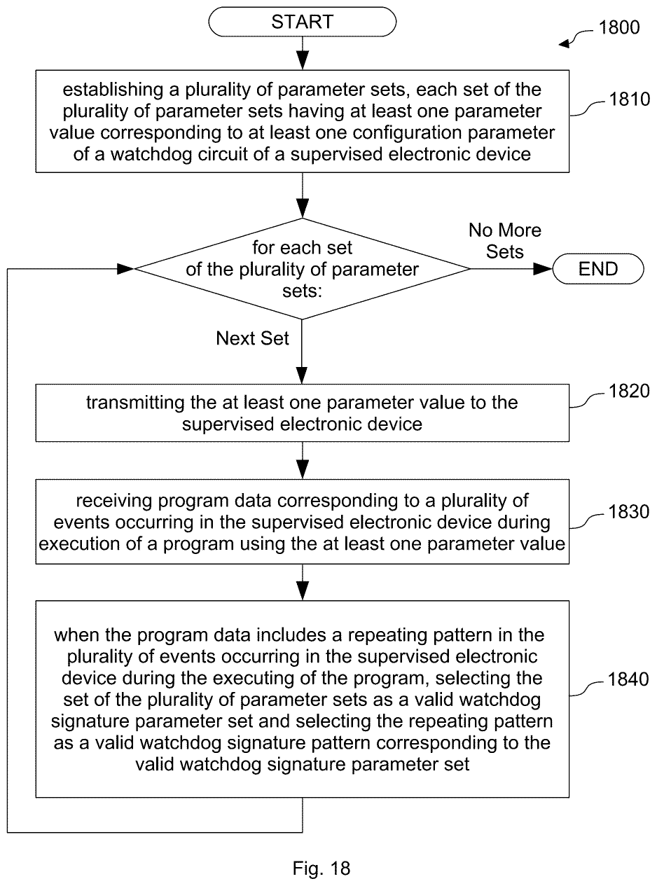

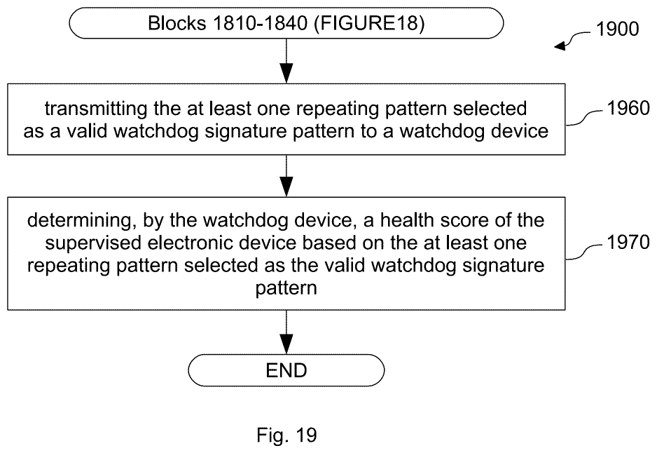

FIG. 18 illustrates a flow chart of an example method 1800 for determining a signature pattern for monitoring the operation of a processor. According to one example, method 1800 may begin at block 1810. The initialization point for method 1800 and the order of blocks 1810 through 1840 may vary depending on implementation.

At block 1810, a plurality of parameter sets may be established, each set of the plurality of parameter sets having at least one parameter value corresponding to at least one configuration parameter of a watchdog circuit of a supervised electronic device. (FIGS. 16 and 17 and related descriptions, below, provide examples of parameter sets according to the present disclosure.) In an example, the at least one configuration parameter of the watchdog circuit may include a clock divisor parameter (e.g., for programming clock divider 1333, FIG. 13).

Blocks 1820-1840 may be performed for each set of the plurality of parameter sets until there are no more sets in the plurality of parameter sets. At block 1820, the at least one parameter value may be transmitted to the supervised electronic device.

At block 1830, program data corresponding to a plurality of events occurring in the supervised electronic device during execution of a program using the at least one parameter value may be received (e.g., via input signal 120, 325). In an example, the plurality of events occurring in the supervised electronic device during the executing of the program may include a plurality of system interrupt events (INT1-INTn, FIG. 3) occurring in the supervised electronic device during the executing of the program. In the same or different examples, the plurality of system interrupt events may be included in the program data (e.g., PWM signal 366) based on a priority ranking of the system interrupt events occurring in the supervised electronic device during the executing of the program (e.g., RANK_DIS=0, FIG. 13). In the same or different examples, the program data may be based on sampling the plurality of system interrupt events at a frequency based at least on the clock divisor parameter.

At block 1840, when the program data includes a repeating pattern in the plurality of events occurring in the supervised electronic device during the executing of the program, the set of the plurality of parameter sets may be selected as a valid watchdog signature parameter set and the repeating pattern may be selected as a valid watchdog signature pattern corresponding to the valid watchdog signature parameter set (see FIGS. 16 and 17 and related descriptions).

Although FIG. 18 discloses a particular number of operations related to method 1800, method 1800 may be executed with greater or fewer operations than those depicted in FIG. 18. For example, FIG. 19 provides an example of additional operations that may be performed. In addition, although FIG. 18 discloses a certain order of operations to be taken with respect to method 1800, the operations comprising method 1800 may be completed in any suitable order.

FIG. 19 illustrates a flow chart of an example method 1900 for determining a signature pattern for monitoring the operation of a processor. According to one example, method 1900 may begin with blocks 1810-1840 (FIG. 18) and then proceed to block 1960. At block 1960, the at least one repeating pattern selected as a valid watchdog signature pattern may be transmitted to a watchdog device. At block 1270, the watchdog device may determine a health score of the supervised electronic device based on the at least one repeating pattern selected as the valid watchdog signature pattern.

Methods 800-1200 and 1800-1900 may be implemented using apparatus 100-700 or any other system operable to implement methods 800-1200 and 1800-1900. Although examples have been described above, other variations and examples may be made from this disclosure without departing from the spirit and scope of these disclosed examples.

FIG. 16 illustrates a block diagram of a software signature pattern extraction and optimization fixture 1600 that may be used by methods 1100-1200. In an example, fixture 1600 may be used to create a recognizable software signature. In an example, the PWM output may be analyzed during the implementation and testing stage, using a system running the real code. This analysis may be performed by a PC application that may log the PWM profile evolution and then identify possible “fingerprints” (patterns) that may be used by a watchdog/supervisor device. Because changing parameters of the PWM generation logic on the supervised device may not impact the application running on the supervised device, the optimization process may be automated by fixture 1600, by running an application multiple times with different sets of parameter combinations and iteratively mining the “watchdog data” until one or more acceptable options for a software signature pattern are identified. Parameter sets may include various combinations of values for configuration parameters used by the PWM generation logic on the supervised device. These configuration parameters may include: a prescaler value (for clock division), identification of the clock domain that feeds the prescaler, the system interrupts that are considered by the priority decoder and the priority scheme for race conditions between simultaneous interrupts, the duty cycle values assigned to each system interrupt, and the value of the special duty cycle (e.g., 0%, 100%, or 50%), among others.

A set of parameters that leads to a smaller and coherent, recurrent pattern (with minimum number of probabilistic slots) may be chosen to be used for application health supervision. In an example, fixture 1600 may try different values/combinations of the following parameters for the supervised device: (1) prescaler value (sets the event granularity), (2) clock domain that feeds the prescaler, (3) system interrupts that are considered by the priority decoder, (4) priority scheme for race conditions between simultaneous interrupts, (5) duty cycle values assigned to each system interrupt, and (6) the special duty cycle value (0%, 100%, or 50%). In the same or different examples, fixture 1600 may decrease the pattern extraction processing time by (1) setting the maximum length for the pattern (which is limited by the supervisory side resources), and (2) limiting the number of (repetitive) interrupts used to generate the software fingerprint. This may result in a lower number of iterations for pattern size and each combination of parameters (number of interrupts and ranks) that are pushed to the supervised system.

Fixture 1600 may use various algorithms (including machine learning algorithms or traditional analytics) to identify acceptable program signature patterns.

Fixture 1600 may be used to test performance of the watchdog/supervisory device using the chosen signature pattern. For example, once a set of acceptable patterns are identified, the PC may automatically push those patterns to the supervisory side and test the system in run-time. The pattern valid flag may be output by the supervisor and, based on that flag, the PC may determine if the pattern is valid for a minimum number of cycles. The PC may discard patterns that do not meet a predetermined threshold (i.e., generates too many invalid pattern flags). The acceptable signature patterns may be used in the final application. In some examples, the watchdog/supervisory device may be used as cybersecurity deterrence (e.g. in combination with a deadman timer interrupt and other interrupt sources) since an altered application's signature pattern may differ from the chosen signature pattern.

In some examples, the PC software in fixture 1600 may perform the following to identify acceptable program signature patterns:
1. Push the first set of parameters to configure the watchdog logic (e.g., logic 1300, FIG. 13) in the supervised device.
2. Run software on the supervised device for a period of time to collect data. In examples, the maximum pattern length may be a function of maximum reaction time of a failsafe mechanism (FST). Accordingly, in this example, for a certain granularity (PWM frequency) the pattern length may be a function of FST/2 so that two consecutive valid patterns may be identified within time (FST) to conclude the system is healthy.
3. Probe all patterns ranging from 2 symbols to k symbols, where k=FST/(2*symbol_time).
4. Because the pattern may start anywhere in the data (as it repeats itself), fill the reference pattern with the sequence starting from position 1 and compare it (assuming the current template had c symbols) with the portion of data string starting from c+1, then 2c+1, and so on. For each comparison, calculate the matching score that represents the number of position matches within the data string and the reference. Calculate the average of the string of scores.
5. The next iteration may shift the reference by 1 position (the location of the start of the pattern is unknown), by copying to the reference pattern the symbols from position 2 to position c+1 and the comparing from c+2, 2c+1, etc. Calculate the score average.
6. Continue until shifting the window to c position and calculating the score average. As a result, there will be a string of average scores. The reference pattern with the maximum score may be saved as a possible candidate and for this pattern the score per symbol may be calculated (the score divided by the number of pattern symbols). This new score (per symbol) may help to compare the scores of patterns with different sizes.
7. Increase the number of symbols within the reference pattern (and perform steps 4-6) until k=FST/2.
8. Select a reasonably small number of patterns (e.g., 10%) with the highest score/symbol. For these patterns, repeat steps 4-7, but this time at each step will consider the power of 2 score that indicates which position matches with the reference. For example if 1^{st}, 2^{nd} and 4^{th} positions match in a pattern with five symbols, the score will be 1*2\hat{ }0+1*2\hat{ }1+0*2\hat{ }2+1*2\hat{ }3+0*2\hat{ }4=11. Group the matching based on power of 2 scores and select the one that has a smaller number of variants with the same power of 2 scores. The sum of symbols for elements outside the majority of elements with the same score may not exceed the FST, so all cases outside the range may be eliminated.
9. If no element is determined to be valid for a certain set of parameters, make invalid the usage for this set.
10. The PC may push another set of parameters corresponding to the parameter set that involves the maximum number of interrupts and resulted in the best score.
11. The stability of supervision can be tested with the chosen pattern and corresponding set of parameters. A system that triggers safety disconnect in normal operation may be determined to be unstable.

FIG. 17 illustrates a block diagram of an example system 1700 for monitoring the operation of a processor. A watchdog function (on the supervisor side) may be implemented through a dual line digital interface, consisting of the supervisory side, from a Timer Capture Input Interface (TMR CAPTURE) and a safe GPIO (configured as a safe output) able to reset the main/supervised MCU in case of malfunction.

A bidirectional and asynchronous serial connection may be used for data interchange between the two entities. In the FIG. 17 example, the signals of the supervised MCU may be electrically isolated from the supervisor MCU to reduce the likelihood that an electrical anomaly in one disturbs the other. Examples of electrical isolation may include, optical/electrical isolation, capacitive isolation, resistive isolation, and delay buffers. The supervised MCU and supervisor MCU may be packaged separately or may be packaged together. In some examples, isolated power and clock signals may drive each MCU. In some examples, multiple supervised MCUs may be supervised by a single supervisor MCU. In some such examples, the supervised MCUs may execute the same code and vote, such as in a high redundancy environment.

On the main MCU side, a watchdog dedicated macro (e.g., a timer with PWM output, e.g., FIG. 13) may be implemented to digitally feed the TMR CAPTURE on supervisory side and to run independently, without additional code needs, which may simplify the SIL process compliance in terms of inserting health monitoring code. The watchdog dedicated macro may provide the following programmable parameters (using registers), and the values of these parameters may be selected in an application-specific manner:
1. Prescaler value (sets the event granularity)
2. Clock domain that feeds the prescaler
3. System interrupts that are considered by the priority decoder and the priority scheme for race conditions between simultaneous interrupts
4. Duty cycle values assigned to each system interrupt
5. Special duty cycle value (0%, 100%, or 50%)

Based on the number of system interrupts encoded in the pattern and the software complexity of a main application running on the supervised MCU, the pattern signature size and PWM granularity (prescaler value) requirements may differ. However, the main decoding structure in the supervisor MCU may remain the same. Consequently, an application change on the supervised MCU may not require a change to the supervisor code.

Systems and methods according to the present disclosure may have a number of advantages. In some examples, application function calls may not be needed to implement the health check which may be performed in hardware (e.g., logic 1300, FIG. 13). Thus, a change in a software application may involve only a change in the program signature pattern stored in a memory on the supervisory device. In the same or different examples, the present disclosure allows the clock frequency of the supervised device to be continuously and independently evaluated from the pattern detection. In the same or different examples, the pattern detection can be used to spot cybersecurity intrusion. In the same or different examples, as the PWM output frequency may dictate the pattern granularity, the match detection engine may be simplified as the output becomes synchronous. In the same or different examples, pattern recognition may not depend on the supervised device clock frequency accuracy. Thus, frequency alteration fault and pattern mismatching may be checked independently. In the same or different examples, the data output feature (asynchronous bidirectional data I/O) may be used to debug in-field complex problems by programming the supervised device interrupt logic for that purpose. In the same or different examples, when a new software version is available, the testing fixture may be used to automate the extraction and optimize pattern detection based on how the macro parameters are handled. In the same or different examples, a recognizable pattern may be determined automatically with a computer/cluster of computers that may log and program all combinations of application interrupts and then analyze the log.

Thus, systems and methods monitoring the operation of a processor may be provided. Changes may be made to the present disclosure without departing from the spirit and scope of the disclosure.

We claim:

1. A device comprising:
a program signature pattern stored in a first memory, the program signature pattern corresponding to an external program to be run on an external device;
an input pin for receiving an input signal;
a timer module configured to capture a frequency and a captured duty cycle of the input signal over time;
a decoder configured to determine an external program state of the external program based on the captured duty cycle;
a second memory configured to store the external program state;
a cross correlator configured to determine an external program health score based on comparing the program signature pattern stored in the first memory with the external program state stored in the second memory; and
a reset logic configured to assert a reset output signal when the external program health score is below a predetermined threshold.

2. The device of claim 1, wherein the program signature pattern comprises data representing a sequence of system interrupts predicted to be triggered by the external program when run on the external device.

3. The device of claim 1, wherein the cross correlator is configured to use a sliding window technique to synchronize the program signature pattern stored in the first memory and the external program state stored in the second memory.

4. The device of claim 1, wherein the first memory is a circular buffer and the second memory is a FIFO.

5. The device of claim 1, comprising:
a clock validator configured to validate, based on the frequency and the captured duty cycle of the input signal over time, a supervised clock signal from the external device.

6. A system comprising:
a first device having:
a system clock;
a reset input pin;
a system clock divider configured to generate a divided system clock based on the system clock;
a pulse width modulation circuit configured to generate a pulse width modulated signal having a duty cycle, wherein:
a counter of the pulse width modulation circuit is configured to be clocked by the divided system clock; and
the duty cycle of the pulse width modulated signal is configured to encode a plurality of system interrupt signals during execution of an application program; and
a watchdog output pin coupled to the pulse width modulated signal; and
a second device having:
a first memory configured to store a program signature pattern, the program signature pattern corresponding to the application program to be executed on the first device;
a watchdog input pin coupled to the watchdog output pin of the first device, the watchdog input pin for receiving a watchdog input signal;
a timer module configured to capture a frequency and a captured duty cycle of the watchdog input signal over time;
a decoder configured to determine an external program state of the application program based on the captured duty cycle;
a second memory configured to store the external program state;
a cross correlator configured to determine an external program health score based on comparing the program signature pattern stored in the first memory with the external program state stored in the second memory;
a reset output pin coupled to the reset input pin of the first device; and
a reset logic configured to assert a reset signal coupled to the reset output pin when the external program health score is below a predetermined threshold.

7. The system of claim 6, wherein the duty cycle of the pulse width modulated signal is configured to encode the plurality of system interrupt signals based on a priority ranking of the plurality of system interrupt signals.

8. The system of claim 6, wherein the program signature pattern comprises data representing a predicted sequence of the plurality of system interrupt signals during execution of the application program on the first device.

9. The system of claim 6, wherein the cross correlator is configured to use a sliding window technique to synchronize the program signature pattern stored in the first memory and the external program state stored in the second memory.

10. The system of claim 6, wherein the pulse width modulation circuit configured to update the duty cycle of the pulse width modulation signal when the counter reaches a maximum value.

11. The system of claim 6, wherein the first device includes a reset circuit configured to initiate a system reset based on the reset input pin.

12. The system of claim 6, wherein the second device includes a clock validator configured to validate, based on the frequency and the captured duty cycle of the watchdog input signal over time, the first device system clock.

13. The system of claim 6, comprising a bidirectional and asynchronous serial data connection between the first device and the second device.

14. The system of claim 6, wherein:
the program signature pattern includes at least one probabilistic data; and
the second device having:
a first additional cross correlator configured to generate a first pattern valid signal based on comparing a first value from the program signature pattern stored in the first memory with the external program state stored in the second memory; and
a second additional cross correlator configured to generate a second pattern valid signal based on comparing a second value from the program signature pattern stored in the first memory with the external program state stored in the second memory; and
wherein the reset logic configured to assert the reset signal coupled to the reset output pin based on the external program health score, the first pattern valid signal, and the second pattern valid signal.

15. A method comprising:
storing a software fingerprint in a memory on a watchdog device, the software fingerprint based on software events predicted to occur during execution of a software program on a subject device, the software program substantially without health check related code;
receiving an encoded signal encoding a plurality of software events that occur during execution of the software program on the subject device;
decoding the encoded signal as a decoded signal on the watchdog device and comparing the decoded signal to the software fingerprint stored in the memory on the watchdog device;
determining a software program health score based on comparing the software fingerprint stored in the memory on the watchdog device with the decoded signal; and
asserting a reset output for resetting the subject device when the software program health score is below a predetermined threshold.

16. The method of claim 15, comprising validating a system clock of the subject device based on the encoded signal.

17. The method of claim 15, wherein the software events predicted to occur comprise system interrupt events and the software fingerprint is based on a priority ranking of the system interrupt events.

18. The method of claim 17, comprising:
determining that the software program has been altered when the software program health score is below the predetermined threshold.

19. The method of claim 15, wherein the comparing the software fingerprint stored in the memory on the watchdog device with the decoded signal comprises using a sliding window technique to synchronize the software fingerprint stored in the memory on the watchdog device with the decoded signal.

20. The method of claim 15, wherein determining the software program health score is based on artificial intelligence inferencing.
